(19) United States
(12) Patent Application Publication
(10) Pub. No.: US 2026/0151879 A1
(43) Pub. Date: Jun. 4, 2026

(54) TOOL BIT

(71) Applicant: Milwaukee Electric Tool Corporation, Brookfield, WI (US)

(72) Inventor: Roger D. Neitzell, Palmyra, WI (US)

(21) Appl. No.: 19/461,304

(22) Filed: Jan. 27, 2026

Related U.S. Application Data
(63) Continuation of application No. 17/718,827, filed on Apr. 12, 2022, now Pat. No. 12,564,918.
Application No. 17/718,827 is a continuation of application No. 16/027,691, filed on Jul. 5, 2018, now abandoned.
Application No. 16/027,691 is a continuation of application No. 14/596,739, filed on Jan. 14, 2015, now Pat. No. 10,022,845.
(60) Provisional application No. 61/928,266, filed on Jan. 16, 2014.

(51) Int. Cl. B25B 15/00; B22F 3/22; B22F 5/00; B22F 7/06; B25B 23/00

(52) U.S. Cl. CPC B25B 15/002; B22F 3/225; B22F 7/06; B25B 15/005; B25B 23/0007; B22F 2005/001; B22F 2998/10

(57) ABSTRACT

A method of manufacturing a tool bit includes injecting a first material into a first portion of a mold to create a working end of the tool bit. The method of manufacturing the tool bit also includes injecting a second material into a second portion of the mold to create a shank of the tool bit. The first material has a higher hardness than the second material.

### CROSS-REFERENCES TO RELATED APPLICATIONS

This application is a continuation of co-pending U.S. patent application Ser. No. 17/718,827 filed on Apr. 12, 2022, which is a continuation of U.S. patent application Ser. No. 16/027,691 filed on Jul. 5, 2018, now abandoned, which is a continuation of U.S. patent application Ser. No. 14/596,739 filed on Jan. 14, 2015, now U.S. Pat. No. 10,022,845, which claims priority to U.S. Provisional Patent Application No. 61/928,266 filed on Jan. 16, 2014, the entire contents of all of which are incorporated herein by reference.

### FIELD OF THE INVENTION

The present invention relates to tool bits, and more particularly to tool bits configured for interchangeable use with a driver.

### BACKGROUND OF THE INVENTION

Tool bits, or insert bits, are often used with drivers configured to interchangeably receive the bits. For example, typical insert bits each include a hexagonal drive portion, a head or tip configured to engage a fastener, and a cylindrical shank connecting the drive portion and the tip. Drivers include a socket having a hexagonal recess in which the hexagonal drive portion of an insert bit is received and a stem or shank extending from the socket, which can be coupled to a handle for hand-use by an operator, or a power tool (e.g., a drill) for powered use by the operator. An interference fit between the hexagonal drive portion of the insert bit and the socket may be used to axially secure the insert bit to the driver, or quick-release structure may be employed to axially secure the insert bit to the driver.

### SUMMARY OF THE INVENTION

The invention provides, in one aspect, a method of manufacturing a tool bit. The method includes injecting a first material into a first portion of a mold to create a working end of the tool bit. The method includes injecting a second material into a second portion of the mold to create a shank of the tool bit. The first material has a higher hardness than the second material.

The invention provides, in another aspect, a tool bit including a working end formed from a first material having a first hardness. The tool bit includes a shank formed from a second material having a second hardness. The first hardness is greater than the second hardness. The working end and the shank are integrally formed. The shank includes a plurality of individual strands radially offset from a central longitudinal axis of the tool bit to create voids therebetween.

The invention provides, in yet another aspect, a tool bit including a working end formed from a first material having a first hardness. The tool bit includes a shank formed from a second material having a second hardness. The first hardness is greater than the second hardness. The working end and the shank are integrally formed. The shank includes a plurality of individual strands, each of which is twisted about a central longitudinal axis of the tool bit.

Other features and aspects of the invention will become apparent by consideration of the following detailed description and accompanying drawings.

### BRIEF DESCRIPTION OF THE DRAWINGS

FIG. 1 is a perspective view of a tool bit in accordance with an embodiment of the invention.

FIG. 2 is a perspective view of a tool bit in accordance with another embodiment of the invention.

FIG. 3 is a perspective view of a tool bit in accordance with yet another embodiment of the invention.

FIG. 4 is a perspective view of a tool bit in accordance with a further embodiment of the invention.

FIG. 5 is a perspective view of a tool bit in accordance with another embodiment of the invention.

FIG. 6 is a perspective view of the tool bit of FIG. 5 with a working end of the bit removed.

FIG. 7 is a side view of the tool bit of FIG. 5.

FIG. 8 is a cross-sectional view of the tool bit of FIG. 5 through section line 8-8 in FIG. 7.

FIG. 9 is a front view of the tool bit of FIG. 5.

FIG. 10 is a rear view of the tool bit of FIG. 5.

FIG. 11 is a schematic of a process for manufacturing the tool bit of FIG. 5.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

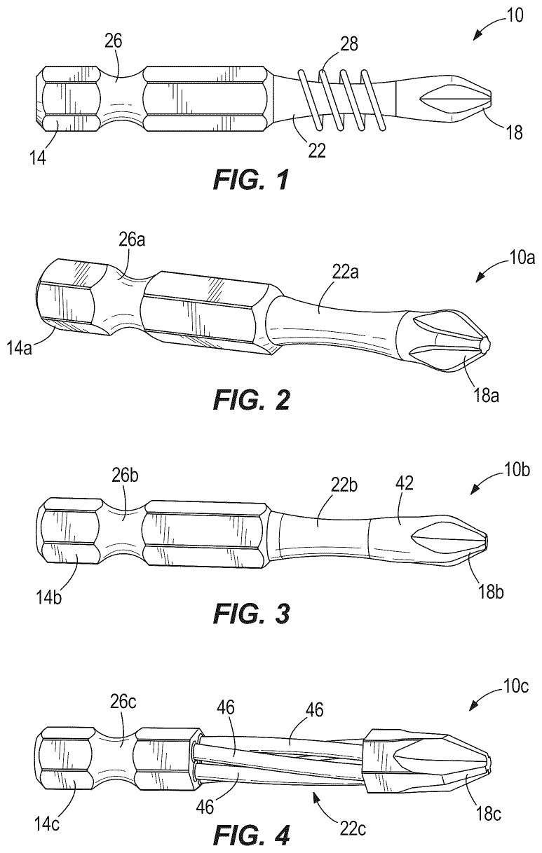

FIG. 1 illustrates a tool bit 10 including a hexagonal drive portion 14, a working end, head, or tip 18 configured to engage a fastener, and a shank 22 interconnecting the drive portion 14 and the tip 18. The hexagonal drive portion 14 is intended to be engaged by any of a number of different tools, adapters, or components to receive torque from the tool, adapter, or component to rotate the bit 10. For example, the bit 10 may be utilized with a driver including a socket (not shown) having a corresponding hexagonal recess in which the hexagonal drive portion 14 of the bit 10 is received. The driver may also include a stem extending from the socket, which may be coupled to a handle for hand-use by an operator or to a chuck of a power tool (e.g., a drill) for powered use by the operator. A sliding, frictional fit between the hexagonal drive portion 14 of the bit 10 and the socket may be used to axially secure the bit 10 to the driver. Alternatively, a quick-release structure may be employed to axially secure the bit 10 to the driver. As shown in FIG. 1, the drive portion 14 of the bit 10 includes a groove 26 into which the quick-release structure (e.g., a ball detent) may be positioned to axially secure the bit 10 to the driver. Alternatively, the groove 26 may be omitted from the drive portion 14 of the bit 10 should a sliding frictional fit between the socket and the drive portion 14 be employed.

With continued reference to FIG. 1, the tip 18 of the bit 10 is configured as a Philips-style tip 18. Alternatively, the tip 18 may be differently configured to engage different style fasteners. For example, the tip 18 may be configured as a straight blade (otherwise known as a “regular head”) to engage fasteners having a corresponding straight slot. Other tip configurations (e.g., hexagonal, star, square, etc.) may also be employed with the bit 10.

In the illustrated embodiment of FIG. 1, different manufacturing processes can be used to impart a greater hardness to the tip 18 compared to the hardness of the shank 22. For example, the entire bit 10 can be heat treated to an initial, relatively low hardness level and then a secondary heat treating process can be applied only to the tip 18 to increase the hardness of the tip 18 to a relatively high hardness level to reduce the wear imparted to the tip 18 during use of the bit 10. Alternatively, in a different manufacturing process, the entire bit 10 can be heat treated to an initial, relatively high hardness level and then a secondary annealing process (e.g., an induction annealing process using an induction coil 28) can be applied to the shank 22 (and, optionally, the drive portion 14) to reduce the hardness of the shank 22 (and optionally the drive portion 14) to a relatively low hardness level to increase the torsional resiliency of the shank 22, and therefore its impact resistance, during use of the bit 10.

In operation of the bit 10, the concavity of the shank 22 is configured to increase the impact resistance or the toughness of the bit 10, such that the drive portion 14 and the shank 22 of the bit 10 are allowed to elastically deform or twist relative to the tip 18 about a longitudinal axis of the bit 10. Specifically, the polar moment of inertia of the shank 22 is decreased by incorporating the concavity, thereby reducing the amount of torsion required to elastically twist the shank 22, compared to a shank having a cylindrical shape. The reduced hardness of the shank 22 relative to the tip 18 further increases the impact resistance of the bit 10, compared to a similar bit having a uniform hardness throughout.

FIG. 2 illustrates a tool bit 10a in accordance with another embodiment of the invention, with like reference numerals with the letter “a” assigned to like features as the tool bit 10 shown in FIG. 1. Rather than using multiple heat treating processes to impart the desired hardness profile to the bit 10a, the tip 18a of the bit 10a is made of a first material having a first hardness, and the shank 22a of the bit 10a is made of a second material having a second, different hardness. The first and second materials are chosen such that the first hardness is greater than the second hardness. Accordingly, the hardness of the tip 18a is greater than the hardness of the shank 22a to reduce the wear imparted to the tip 18a during use of the bit 10a. The reduced hardness of the shank 22a relative to the tip 18a, however, also increases the impact-resistance of the bit 10a as described above.

In the particular embodiment of the bit 10a shown in FIG. 2, an insert molding process, such as a two-shot metal injection molding (“MIM”) process, is used to manufacture the bit 10a having the conjoined tip 18a and shank 22a made from two different metals. Particularly, the tip 18a is made of a metal having a greater hardness than that of the shank 22a and the drive portion 14a. Because the dissimilar metals of the tip 18a and the shank 22a, respectively, are conjoined or integrally formed during the two-shot MIM process, a secondary manufacturing process for connecting the tip 18a to the remainder of the bit 10a is unnecessary. The MIM process will be described in detail below. Alternatively, rather than using an insert molding process, the tip 18a may be attached to the shank 22a using a welding process (e.g., a spin-welding process).

FIG. 3 illustrates a tool bit 10b in accordance with yet another embodiment of the invention, with like reference numerals with the letter “b” assigned to like features as the tool bit 10 shown in FIG. 1. Rather than using different materials during the manufacturing process to create the tool bit 10b, the tip 18b includes a layer of cladding 42 having a hardness greater than the hardness of the shank 22b. Furthermore, the hardness of the cladding 42 is greater than the hardness of the underlying material from which the tip 18b is initially formed. The cladding 42 may be added to the tip 18b using any of a number of different processes (e.g., forging, welding, etc.). The addition of the cladding 42 to the tip 18b increases the wear resistance of the tip 18b in a similar manner as described above in connection with the bits 10, 10a.

FIG. 4 illustrates a tool bit 10c in accordance with a further embodiment of the invention, with like reference numerals with the letter “c” assigned to like features as the tool bit 10 shown in FIG. 1. At least one of the hexagonal drive portion 14c, the tip 18c, and the shank 22c is made using a three-dimensional printing process. With such a process, different materials (e.g., metals) can be used for printing the tip 18c and the shank 22c to impart a greater hardness to the tip 18c relative to the shank 22c to reduce the wear imparted to the tip 18c during use of the bit 10c. For example, the tip 18c of the bit 10c may be printed from a first material having a first hardness, and the shank 22c of the bit 10c may be printed from a second material having a second, different hardness. The first and second materials are chosen such that the first hardness is greater than the second hardness. The tip 18c and the shank 22c may be conjoined or integrally formed during the printing process. Alternatively, separate printing processes using different materials may be used and a secondary manufacturing process (e.g., welding, etc.) may be used for joining the tip 18c and the shank 22c.

In the illustrated embodiment shown in FIG. 4, the shank 22c is comprised of several individual strands 46 interconnecting the tip 18c and the drive portion 14c. Each of the strands 46 is offset from a longitudinal axis of the bit 10c in a radially outward direction, thereby creating a void between the collection of individual strands 46. Such a configuration of the shank 22c decreases the polar moment of inertia of the shank 22c, thereby reducing the amount of torsion required to elastically twist the shank 22c compared to a shank having a solid, cylindrical shape. The reduced hardness of the shank 22c relative to the tip 18c further increases the impact resistance of the bit 10c, compared to a similar bit having a uniform hardness throughout.

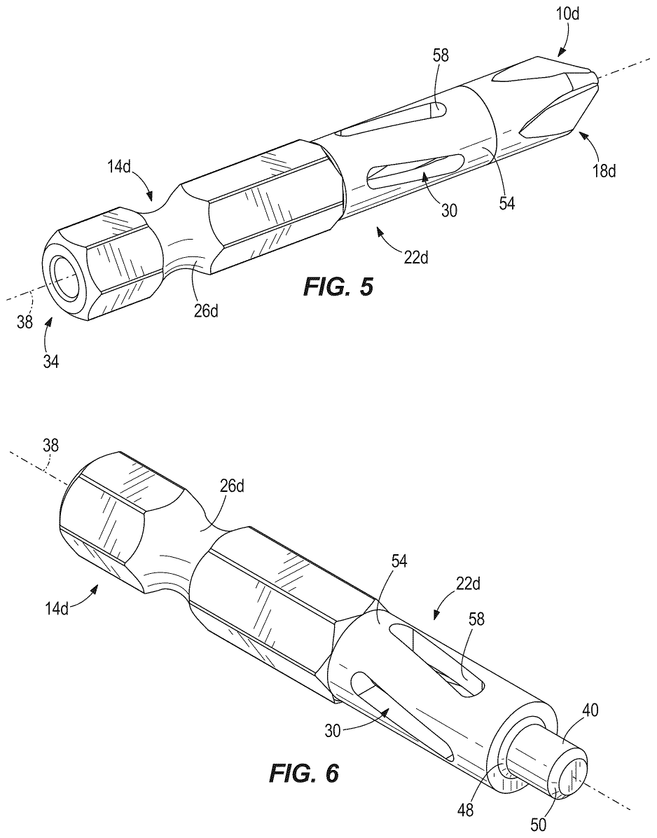

FIG. 5 illustrates a tool bit 10d in accordance with another embodiment of the invention, with like reference numerals with the letter “d” assigned to like features as the tool bit 10 shown in FIG. 1. The tool bit 10d includes a hollow core 30 that extends from a portion of the shank 22d adjacent the tip 18d, through the shank 22d, and towards the hexagonal drive portion 14d (FIG. 8). In the illustrated embodiment of the bit 10d, the hollow core 30 extends entirely through the hexagonal drive portion 14d, terminating in an opening 34 opposite from the tip 18d (FIGS. 5 and 8). Alternatively, the core 30 may terminate prior to reaching the distal end of the drive portion 14d. For example, the core 30 may extend entirely through the shank 22d, but only partially through the drive portion 14d. Or, the core 30 may terminate prior to reaching the drive portion 14d. As shown in FIG. 8, the hollow core 30 includes a substantially uniform diameter D1 along its length L1. The tool bit 10d includes a major longitudinal axis 38, which also defines a rotational axis of the tool bit 10d, that is collinear or coaxial with the hollow core 30. Alternatively, the hollow core 30 may terminate prior to reaching the end of the drive portion 14d opposite the tip 18d, so that the opening 34 is omitted. For example, in another embodiment of the tool bit, the hollow core 30 may coincide only with the shank 22d, with the length L1 of the hollow core 30 being substantially equal to that of the shank 22d.

For the two-inch bit 10d shown in FIG. 8, the length L1 of the hollow core 30 is about 1.45 inches to about 1.53 inches, with a nominal length L1 of about 1.49 inches. Furthermore, the diameter D1 of the hollow core 30 is about 0.100 inches to about 0.150 inches, with a nominal diameter D1 of about 0.125 inches. As a result, a ratio of the length L1 to the diameter D1 of the hollow core 30 is about 9.6:1 to about 15.3:1, with a nominal ratio of about 11.9:1. Alternatively, the ratio of the length L1 to the diameter D1 of the hollow core 30 may be greater than about 15.3:1 or less than about 9.1:1 to accommodate different size or length bits 10. In addition, the ratio of the total length of the two-inch bit 10d to the length L1 of the hollow core 30 is about 1.3:1 to about 1.4:1, with a nominal ratio of about 1.35:1. Alternatively, the ratio of the total length of the bit 10d to the length L1 of the hollow core 30 may be greater than about 1.4:1 or less than about 1.3:1 to accommodate different size or length bits 10.

With reference to FIG. 6, the tip 18d is omitted from the tool bit 10d exposing a protrusion 40 extending from the shank 22d and coaxial with the major longitudinal axis 38. As is described in greater detail below, the protrusion 40 facilitates manufacturing the tool bit 10d using the two-shot MIM process. The protrusion 40 defines a cylindrical shape having a fillet 48 and a chamfer 50 at opposite ends of the protrusion 40. Alternatively, the protrusion 40 may be differently configured as a cone, a semi-sphere, or the like. Further, the protrusion 40 may be configured with one or more radially extending keyways, splines, or teeth, or the protrusion 40 may be cylindrical yet offset from the longitudinal axis 38, to facilitate torque transfer between the shank 22d and the tip 18d. As a further alternative, the protrusion 40 may be formed on the tip 18d, and the shank 22d may be molded around the protrusion 40 thereby positioning the protrusion 40 within the core 30.

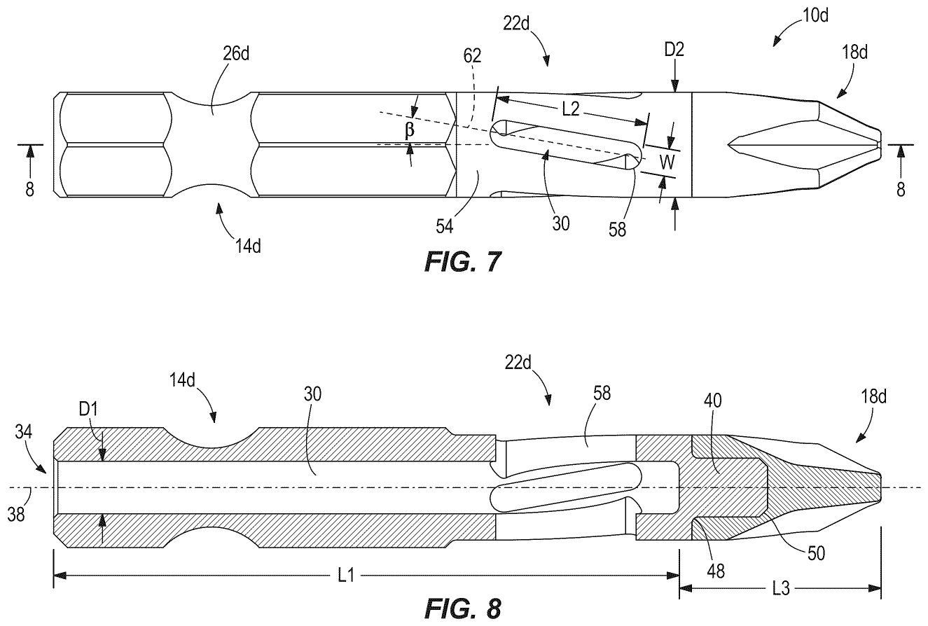

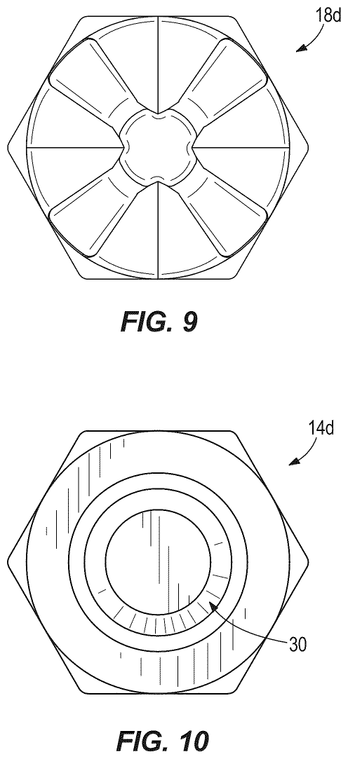

With reference to FIGS. 5-7, the shank 22d is defined by a peripheral surface 54 that extends between the working end 18d and the hexagonal drive portion 14d. The peripheral surface 54 defines a uniform diameter D2 of the shank 22d (FIG. 7). Alternatively, the shank 22d may be differently configured. For example, in another embodiment of the tool bit, the shank 22d may be configured to include a non-uniform diameter with a concave shape similar to the tool bits 10, 10a, and 10b.

The shank 22d includes slots 58 spaced about the peripheral surface 54 at 90 degree angular increments, with each of the slots 58 defining a minor longitudinal axis 62 (FIG. 7). The slots 58 extend radially with respect to the major longitudinal axis 38 between the hollow core 30 and the peripheral surface 54. Therefore, the slots 58 communicate the hollow core 30 with the ambient surroundings of the tool bit 10. Alternatively, the tool bit 10d may be configured with more or fewer than four slots 58, and the slots 58 may be located or dispersed about the shank 22d at different angular increments other than 90 degrees. For example, in an alternative embodiment of the tool bit 10d, the slots 58 may be omitted entirely and the presence of the hollow core 30 through the shank 22d is sufficient to provide the desired amount impact resistance to the bit 10d. For the two-inch bit 10d shown in FIG. 7, each of the slots 58 includes a length L2 of about 0.250 inches to about 0.350 inches, with a nominal length L2 of about 0.300 inches. Furthermore, the slots 58 include a width W of about 0.030 inches to about 0.100 inches, with a nominal width of about 0.065 inches. As a result, a ratio of the length L2 to the width W of the slots 58 is about 2.5:1 to about 11.7:1, with a nominal ratio of about 4.6:1. Alternatively, the ratio of the length L2 to the width W of the slots 58 may be greater than about 11.7:1 or less than about 2.5:1 to accommodate different size or length tool bits 10d. Regardless of the total length of the bit 10d, a length dimension L3 (FIG. 8) extending between a front end of the core 30 and the distal end of the tip 18d is about 0.38 inches to about 0.58 inches, with a nominal value of 0.48 inches.

With continued reference to FIG. 7, the slots 58 are oriented at an oblique angle β between the major longitudinal axis 38 and the minor longitudinal axis 62. The oblique angle β is about 0 degrees to about 20 degrees, with a nominal value of about 10 degrees. Alternatively, the oblique angle β may be greater than about 20 degrees to accommodate different size or length tool bits 10. In some embodiments, the oblique angle β may be zero degrees, thereby orienting the slots 58 parallel with the longitudinal axis 38. However, orienting the slots 58 with a positive value for angle β as shown in FIG. 7 causes the shank 22d to elongate as it twists (i.e., assuming application of torque to the drive portion 14d in a clockwise direction from the frame of reference of FIG. 10), thereby displacing the tip 18d toward the fastener as it is driven into a workpiece. Accordingly, the contact surface between the fastener head and the tip 18d may be increased simultaneously as the reaction torque applied by the fastener to the bit 10d is increased, reducing the likelihood that the tip 18d slips on the fastener head.

The hollow core 30 and the slots 58 in the tool bit 10d work in conjunction to increase the impact resistance or the toughness of the tool bit 10d, such that the tip 18d of the tool bit 10d is allowed to elastically deform or twist relative to the hexagonal drive portion 14d about the major longitudinal axis 38 of the tool bit 10d. Specifically, the polar moment of inertia of the shank 22d is decreased by incorporating the hollow core 30 and slots 58, thereby reducing the amount of torsion required to elastically twist the shank 22d, compared to a configuration of the shank having a solid cylindrical shape without the slots 58 (e.g., shanks 22, 22a, 22b).

In the illustrated embodiment of the tool bit 10d, the tip 18d made of a first material having a first hardness and the shank 22d is made of a second material having a second, different hardness. Particularly, the hardness of the tip 18d is greater than the hardness of the shank 22d to reduce the wear imparted to the tip 18d during use of the bit 10d. The reduced hardness of the shank 22d relative to the tip 18d, however, also increases the impact-resistance of the bit 10d. For example, the first hardness is about 55 HRC to about 65 HRC, with a nominal hardness of about 62 HRC, while the second hardness is about 40 HRC to about 55 HRC, with a nominal hardness of about 45 HRC. Therefore, a ratio between the first hardness and the second hardness is about 1:1 to about 1.7:1, with a nominal ratio of about 1.4:1. Alternatively, the ratio between the first hardness and the second hardness may be greater than about 1.7:1 to provide optimum performance of the tool bit 10d. The first and second materials are each comprised of a ferrous alloy composition, though different materials may alternatively be used.

As mentioned above, the two-shot metal MIM process is used to manufacture the bit 10d to make the conjoined tip 18d and shank 22d from two different materials. In other embodiments, the two-shot MIM process may be used to manufacture tool bits 10, 10a, 10b, and 10c. Particularly, in the illustrated embodiment of the tool bit 10d, the tip 18d is made from a material having a greater hardness than that of the shank 22d and the hexagonal drive portion 14d. Because the dissimilar materials of the tip 18d and the shank 22d, respectively, are conjoined or integrally formed during the two-shot MIM process, a secondary manufacturing process for connecting the tip 18d to the remainder of the bit 10d is unnecessary. Furthermore, the protrusion 40 provides a greater surface area between the tip 18d and the shank 22d so that the bond between dissimilar metals of the tip 18d and the shank 22d is stronger compared, for example, to using a flat mating surface between the tip 18d and the shank 22d. In addition, the protrusion 40 increases the shear strength of the bit 10d at the intersection of the tip 18d and the shank 22d.

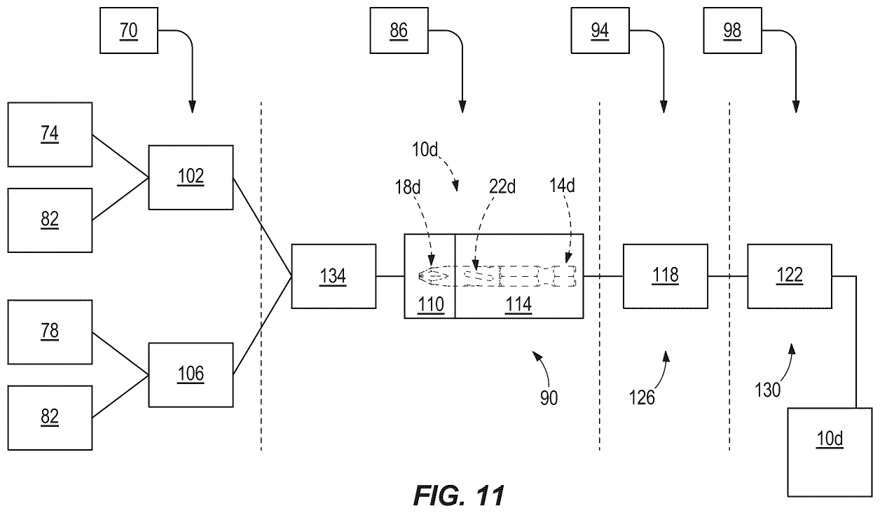

With reference to FIG. 11, the two-shot MIM process includes in sequence a feedstock mixing process 70 to mix the first and the second materials 74, 78 with a binder composition 82, an injection molding process 86 using a mold 90, a debinding process 94 to eliminate the binder composition 82, and a heat treating process 98.

During the feedstock mixing process 70, the binder composition 82 is added to the first and the second materials 74, 78 to facilitate processing through the injection molding process 86. As a result, the first material 74, which is in a powder form, is homogeneously mixed with the binder composition 82 to provide a first feedstock mixture 102 of a determined consistency. In addition, the second material 78, which is also in a powder form, is also homogeneously mixed with the binder composition 82 to provide a second feedstock mixture 106 with substantially the same consistency as the first mixture 102. In the illustrated embodiment of the tool bit 10d, the binder composition 82 includes a thermoplastic binder. Alternatively, the binder composition 82 may include other appropriate binder compositions (e.g., wax). The amount of binder composition 82 in each of the first and second feedstock mixtures 102, 106 is chosen to match the shrink rates of the tip 18d and the drive portion 14d/shank 22d, respectively, during the sintering process 122 described below.

The injection molding process 86 includes processing the first and the second feedstock mixtures 102, 106 through an injection molding machine 134. Particularly, the process 86 includes injecting the first feedstock mixtures 102 into a first portion 110 of the mold 90, and injecting the second feedstock mixture 106 into a second portion 114 of the mold 90. In the illustrated embodiment shown in FIG. 11, the tip 18d of the tool bit 10d is generally formed in the first portion 110 of the mold 90, while the shank 22d and the drive portion 14d of the tool bit 10d are generally formed in the second portion 114 of the mold 90. Upon completion of the injection molding process 86, a temporary (otherwise known in the MIM industry as a “green”) tool bit 126 is produced that includes the first and the second materials 74, 78 and the binder composition 82. The “green” tool bit 126 is larger than the final tool bit 10d due to the presence of the binder composition 82.

The injection molding process 86 may be carried out in various ways to form the “green” tool bit 126. For example, the “green” tool bit 126 can be initially formed along the major longitudinal axis 38 from the hexagonal drive portion 14d to the tip 18, or from the tip 18d to the hexagonal drive portion 14d. Alternatively, the “green” tool bit 126 can be initially formed from a side-to-side profile as oriented in FIG. 7.

After the injection molding process 86, the “green” tool bit 126 is removed from the mold 90 and proceeds through the debinding process 94. The debinding process 94 eliminates the binder composition 82. During the debinding process 94, the “green” tool bit 126 transforms into a “brown” tool bit 130 (as it is known in the MIM industry) that only includes the first and the second materials 74, 78. In the illustrated embodiment, the debinding process 94 includes a chemical wash 118. Alternatively, the debinding process 94 may include a thermal vaporization process to remove the binder composition 82 from the “green” tool bit 126. The “brown” tool bit 130 is fragile and porous with the absence of the binder composition 82.

To reduce the porosity of the “brown” tool bit 130, the heat treating process 98 is performed to atomically diffuse the “brown” tool bit 130 to form the final tool bit 10d. The heat treating process 98 exposes the “brown” tool bit 130 to an elevated temperature to promote atomic diffusion between the first and the second materials 74, 78, allowing atoms of the dissimilar materials 74, 78 to interact and fuse together. The heat treating process 98 reduces the porosity of the “brown” tool bit 130 to about 95% to about 99% to yield the final tool bit 10d. In the illustrated embodiment, the heat treating process 98 includes a sintering process 122. Alternatively, the debinding process 94 and the heat treating process 98 may be combined as a single process such that, at lower temperatures, thermal vaporization will occur during the debinding process 94 to eliminate the binder composition 82. And, at higher temperatures, atomic diffusion will reduce the porosity in the “brown” tool bit 130 to yield the final tool bit 10d.

Various features of the invention are set forth in the following claims.

What is claimed is:

1. A method of manufacturing a tool bit, the method comprising:
injecting a first material into a first portion of a mold to create a working end of the tool bit; and
injecting a second material into a second portion of the mold to create a shank of the tool bit, the first material having a higher hardness than the second material.

2. The method of claim 1, further comprising mixing each of the first material and the second material with a binder prior to injecting the first and second materials into the mold.

3. The method of claim 2, wherein the binder includes a thermoplastic material.

4. The method of claim 2, wherein the binder includes a wax-based material.

5. The method of claim 2, wherein injecting the first material includes injecting solid particles of the first material into the first portion of the mold, and wherein injecting the second material includes injecting solid particles of the second material into the second portion of the mold.

6. The method of claim 2, further comprising cleaning the tool bit to substantially remove the binder.

7. The method of claim 6, wherein cleaning the tool bit includes using a chemical wash or a thermal vaporization process.

8. The method of claim 6, further comprising using an atomic diffusion process for solidifying the tool bit.

9. The method of claim 8, wherein the atomic diffusion process is a sintering process.

10. The method of claim 1, wherein injecting the first material and the second material comprises injecting solid particles.

11. A tool bit comprising:
a working end formed from a first material having a first hardness; and
a shank formed from a second material having a second hardness, the first hardness being greater than the second hardness,
wherein the working end and the shank are integrally formed, and
wherein the shank includes a plurality of individual strands radially offset from a central longitudinal axis of the tool bit to create voids therebetween.

12. The tool bit of claim 11, further comprising a drive portion interconnected with the working end via the plurality of individual strands.

13. The tool bit of claim 11, wherein the tool bit is made using a three-dimensional printing process or a metal injection molding process.

14. The tool bit of claim 11, wherein the working end includes a tip configured to engage a fastener.

15. The tool bit of claim 14, wherein the tip is configured as a Philips-style tip, a straight blade tip, or as a star-shaped tip.

16. The tool bit of claim 11, wherein each individual strand of the plurality of individual strands includes a smooth outer surface.

17. A tool bit comprising:
a working end formed from a first material having a first hardness; and
a shank formed from a second material having a second hardness, the first hardness being greater than the second hardness,
wherein the working end and the shank are integrally formed, and
wherein the shank includes a plurality of individual strands, each of which is twisted about a central longitudinal axis of the tool bit.

18. The tool bit of claim 17, further comprising a hexagonal drive portion, the shank extending between the hexagonal drive portion and the working end, wherein the shank is configured to elongate when a clockwise torque is applied to the hexagonal drive portion.

19. The tool bit of claim 18, wherein the individual strands are radially offset from the central longitudinal axis to create voids therebetween.

20. The tool bit of claim 19, wherein the tool bit is made using a three-dimensional printing process or a metal injection molding process.
